(19) United States
(12) Patent Application Publication
(10) Pub. No.: US 2008/0047362 A1
(43) Pub. Date: Feb. 28, 2008

(54) METHOD AND DEVICE TO DETERMINE THE Q FACTOR FOR FLOW METERS

(75) Inventors: Frank Kassubek, Baden (DE); Gunter Petri, Sandhausen (DE); Jorg Gebhardt, Mainz (DE); Lothar Deppe, Gottingen (DE); Rene Friedrichs, Rosdorf (DE); Steffen Keller, Karlsruhe (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/843,200

(22) Filed: Aug. 22, 2007

(30) Foreign Application Priority Data
Aug. 24, 2006 (DE) 10 2006 039 726.6

(51) Int. Cl. G01F 1/84

(52) U.S. Cl. 73/861.356

(57) ABSTRACT

Method and device to determine the Q factor for a flow meter, with an exciter unit which can be attached to a meter tube to generate a uniform oscillating movement and a sensor unit to measure the oscillating movement, which is influenced by the flow, of the meter tube, and the measured values of which are analyzed by an analysis unit, which is connected downstream, to determine the desired flow parameter and the Q factor, as specified by a stored computational algorithm.

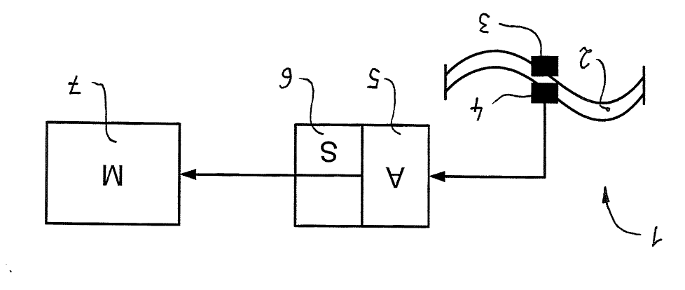

### RELATED APPLICATIONS

This application claims priority under 35 U.S.C. §119 to German Application 10 2006 039 726.6 filed in Germany on Aug. 24, 2006, the entire contents of which are hereby incorporated by reference in their entireties.

### TECHNICAL FIELD

A method and a device to determine the Q factor is disclosed for a flow meter, e.g., a Coriolis flow meter, the meter tube of which, through which the measuring medium flows, is stimulated via at least one exciter unit which generates a uniform oscillation movement, and the oscillation movement of which, which is influenced by the flow, is captured via at least one sensor unit and then analyzed by an analysis unit to determine the desired flow parameter, the Q factor being additionally determined by calculation for diagnostic purposes.

### BACKGROUND INFORMATION

The Q (quality) factor is a measure of specified properties of an oscillating system, and is mainly used in the electrical engineering field in relation to oscillating circuits, or in the field of mechanics in relation to mechanical oscillating systems. The reciprocal of the quality factor Q is called the loss factor d. Diagnostically, the relationship is used so that in the case of a weakly damped oscillating system, a high quality system, i.e. one with a large Q factor, is assumed. A Q factor of 0.5 corresponds in physics to the aperiodic limiting case.

Through the following energy consideration in the case of an oscillating system, the Q factor can be determined (it is assumed that the system oscillates in the natural resonance omega_{—}0 (natural frequency of the undamped system)):

$$Q = \frac{2 π \times energy}{energy loss ofperiod}$$

In the technical field of flow metrology, in which flow meters form mechanical oscillating systems, the Q factor is used as an operating parameter in the determination of mass flow, density and/or viscosity. This is done, for instance, to solve damping problems in the case of flow meters because of increasing deposits in the meter tube. A change of the Q factor can be used to correct the measured values for density or flow. To this extent, the Q factor is used to calibrate the flow meter.

From the general prior art in the field of flow meters, methods of determining the Q factor which use the ratio of resonant frequency to bandwidth are known. However, these input values can only be determined from the measured oscillation courses at great expense.

### SUMMARY

It is therefore an object of the disclosure to create a method and a device to determine the Q factor for a flow meter, with which method and device a sufficiently precise determination of the Q factor is possible in a computationally simple manner.

The disclosure includes the methodological teaching that, to determine the Q factor, the ratio between oscillation amplitude and oscillating force of the meter tube is determined, the Q factor being calculated from the ratio of static and dynamic excursion.

Alternatively, the object on which the disclosure is based can also be achieved in that, to determine the Q factor, the phase position between motive force and system speed is determined, characteristic changes of the internal phase position being determined via a frequency change algorithm to calculate the Q factor directly from them.

The advantage of both alternative exemplary solutions can be that the computational steps which are expressed in them can easily be implemented by a device. For this purpose, the exemplary methods which are the subject of the disclosure can be embodied by a computer program product, which implements a routine to determine the Q factor by corresponding control commands which are held in software. This software can be capable of running on a microprocessor of an associated electronic device, with an exciter unit which can be attached to a meter tube of a flow meter to generate a uniform oscillating movement and a sensor unit to measure the oscillating movement, which influences the flow, of the meter tube, and the measured values of which are analyzed by an analysis unit, which is connected downstream, to determine the desired flow parameter and the Q factor, as specified by a stored computational algorithm.

According to another exemplary technique, which improves the disclosure, it is proposed that the analysis unit has a memory unit to store Q factors, which are each provided with time stamps. At the start of the lifetime of the flow meter, the initial Q factor can be stored in this memory unit, further Q factors with associated time stamps being additionally stored at defined subsequent time intervals during the lifetime of the flow meter, so that the time series which is obtained in this way can be analyzed for diagnostic purposes. In this way, an undesired change, mostly a reduction of the Q factor, which indicates an internal system fault, can be diagnosed, so that when a specified limit value is reached, maintenance or repair actions can be initiated. For instance, replacement of a meter tube in the case of increasing wear or clogging, or other suitable actions, can be initiated at the right time.

It is also proposed that the Q factor should be used with flow meters to test the geometrical symmetry of the meter tube for quality control after production. In this way, a newly produced flow meter can easily be calibrated.

According to another exemplary technique, which improves the disclosure, it is proposed that changes of the Q factor during the lifetime of the flow meter should be displayed to the operating staff via a monitoring unit for monitoring purposes, to make it possible to deduce a system fault from an unusual reduction of the Q factor. As well as the direct display of the Q factor or a value or pictogram which symbolizes it on a monitoring unit directly on the flow meter, it is also conceivable to pass on this information via a communication network to a central monitoring unit of a higher-level control system, or to process it further computationally there.

### BRIEF DESCRIPTION OF THE DRAWING

Further exemplary techniques which improve the disclosure are presented in more detail below on the basis of the FIGURE, together with the description of a exemplary embodiments. The only FIGURE shows a schematic block diagram of a device to implement both method alternatives which are the subject of the disclosure, to determine the Q factor in the case of a flow meter.

### DETAILED DESCRIPTION

According to the FIGURE, an exemplary flow meter 1, e.g., a Coriolis flow meter, has a meter tube 2, through which a free-flowing measuring substance flows in a way which is known per se. The meter tube 2 is put into uniform oscillating movement, here sinusoidal oscillation, via an exciter unit 3. This uniform oscillating movement is influenced by the flow of the measuring medium within the meter tube 2, and the resulting oscillation signal is captured via a sensor unit 4 which is arranged on the meter tube 2, and which here, to achieve a high signal quality, is in the form of a median sensor relative to the meter tube 2. The oscillating movement of the meter tube 2, which is captured by the sensor unit 4, is made available on the input side to an electronic analysis unit 5, in the form of an electronic signal.

One purpose of the analysis unit 5 is to determine the desired flow parameter, here the mass flow of the flow medium through the meter tube 2.

The analysis unit 5 is also used to determine the Q factor, which is used for diagnostic purposes, of the mechanical oscillating system. For this purpose, the hardware of the analysis unit 5 includes a microprocessor, which executes corresponding control commands which are held in software for the stated purpose.

In this sense, according to a first alternative, the Q factor can be determined by determining the ratio between oscillation amplitude and oscillation force of the meter tube 2, the Q factor being calculated from the ratio of static and dynamic excursion. According to a second alternative, the Q factor can also be determined from the phase position between motive force and system speed, characteristic changes of the internal phase position being determined via a frequency change algorithm, and the Q factor can be calculated directly from them.

The analysis unit 5 includes a memory unit 6, on which, among other things, the Q factor at the start of the lifetime of the flow meter 1 is stored. Additionally, the Q factor with associated time stamps is stored in it during the lifetime of the flow meter 1, to analyze the time series which is obtained in this way for diagnostic purposes.

A monitoring unit 7 is connected downstream from the analysis unit 5. The monitoring unit 7 is used for monitoring purposes for the currently determined Q factor. This is thus displayed to the operating staff on site, to make it possible to deduce a system fault from an unusual reduction of the Q factor, and so that this can then be corrected by suitable maintenance or repair actions.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SYMBOL LIST

1 flow meter

2 meter tube

3 exciter unit

4 sensor unit

5 analysis unit

6 memory unit

7 monitoring unit

What is claimed is:

1. A method to determine the Q factor for a meter or a flow meter, the meter tube of which, through which the measuring medium flows, is stimulated via at least one exciter unit which generates an oscillation movement, and the oscillation movement of which, which is influenced by the flow, is captured via at least one sensor unit and then analyzed by an analysis unit to determine the desired flow parameter, a Q factor being additionally determined by calculation for diagnostic purposes,
wherein, to determine the Q factor, the ratio between oscillation amplitude and oscillating force of the meter tube is determined, the Q factor being calculated from the ratio of static and dynamic excursion.

2. A method to determine the Q factor for a flow meter, the meter tube of which, through which the measuring medium flows, is stimulated via at least one exciter unit which generates an oscillation movement, and the oscillation movement of which, which is influenced by the flow, is captured via at least one sensor unit,
wherein to determine the Q factor, the phase position between motive force and system speed on the meter tube is determined, characteristic changes of the internal phase position being determined via a frequency change algorithm to calculate the Q factor directly from them.

3. The method as claimed in claim 1,
wherein the Q factor is used to test the geometrical symmetry of the meter tube.

4. The method as claimed in claim 1,
wherein at the start of the lifetime of the flow meter, the Q factor is stored in a memory unit of the analysis unit, and is additionally stored in it at defined time intervals during the lifetime of the flow meter, so that the time series which is obtained in this way can be analyzed for diagnostic purposes.

5. The method as claimed in claim 1,
wherein changes of the Q factor during the lifetime of the flow meter are displayed to the operating staff via a monitoring unit for monitoring purposes, to make it possible to deduce a system fault from an unusual reduction of the Q factor.

6. A device to execute the method as claimed in claim 1, with an exciter unit which can be attached to a meter tube of a flow meter to generate a uniform oscillating movement and a sensor unit to measure the oscillating movement, which is influenced by the flow, of the meter tube, and the measured values of which are analyzed by an analysis unit, which is connected downstream, to determine the desired flow parameter and the Q factor, as specified by a stored computational algorithm.

7. The device as claimed in claim 6,
wherein the analysis unit has a memory unit to store Q factors, which are each provided with time stamps.

8. The device as claimed in claim 6,
wherein the analysis unit is equipped with a monitoring unit for monitoring purposes for the currently determined Q factor.

9. The device as claimed in claim 6,
wherein the sensor unit is in the form of a median sensor relative to the meter tube.

10. A computer program product for a device as claimed in claim 6 having a routine to determine the Q factor implemented by corresponding control commands which are held in software.

11. The method as claimed in claim 2,
wherein the Q factor is used to test the geometrical symmetry of the meter tube.

12. The method as claimed in claim 2,
wherein at the start of the lifetime of the flow meter, the Q factor is stored in a memory unit of the analysis unit, and is additionally stored in it at defined time intervals during the lifetime of the flow meter, so that the time series which is obtained in this way can be analyzed for diagnostic purposes.

13. The method as claimed in claim 2,
wherein changes of the Q factor during the lifetime of the flow meter are displayed to the operating staff via a monitoring unit for monitoring purposes, to make it possible to deduce a system fault from an unusual reduction of the Q factor.

14. A device to execute the method as claimed in claim 2, with an exciter unit which can be attached to a meter tube of a flow meter to generate a uniform oscillating movement and a sensor unit to measure the oscillating movement, which is influenced by the flow, of the meter tube, and the measured values of which are analyzed by an analysis unit, which is connected downstream, to determine the desired flow parameter and the Q factor, as specified by a stored computational algorithm.

15. A computer program product for a device which can be operated according to a method as claimed in claim 1, wherein a routine to determine the Q factor is implemented by corresponding control commands which are held in software.

16. A computer program product for a device which can be operated according to a method as claimed in claim 2, wherein a routine to determine the Q factor is implemented by corresponding control commands which are held in software.

17. The method as claimed in claim 1,
wherein the meter is a Coriolis flow meter.

18. The method as claimed in claim 2,
wherein the flow meter is a Coriolis flow meter.
